(19) United States
(12) Patent Application Publication
(10) Pub. No.: US 2005/0032403 A1
(43) Pub. Date: Feb. 10, 2005

(54) Structure for mounting electronic component

(75) Inventor: Kanji Ishihara, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/892,258

(22) Filed: Jul. 14, 2004

(30) Foreign Application Priority Data
Aug. 8, 2003 (JP) 2003-290948

(51) Int. Cl. H01R 4/66; H01R 13/648

(52) U.S. Cl. 439/101

(57) ABSTRACT

The present invention provides an EGR sensor capable of preventing an electronic component having polarity, such as a diode, from being mounted in a reverse direction, of simplifying workability, and of preventing the generation of an electrical failure in a circuit. A structure for mounting an electronic component comprises: an electronic component 8 including an element portion 8a having polarity and a pair of lead terminals 8b and 8c; and a holding member 2 including a pair of electrode portions 5 and 6. The pair of lead terminals 8b and 8c of the electronic component 8 is formed to have different lengths, and an abutting portion 7 for positioning the element portion 8a of the electronic component 8 is provided in the holing member 2. The abutting portion 7 is formed between the pair of electrode portions 5 and 6 at a position leaning toward one of the electrode portions from their midpoint. When the electronic component 8 is mounted in the holding member 2 at a reverse position, the element portion 8a abuts to the abutting portion 7, and then at least one of the connection portions of the lead terminals is detached from one of the pair of the electrode portions 5 and 6.

### BACKGROUND OF THE INVENTION

1. Field of the Invention

The present invention relates to a sensor for detecting the position of an EGR valve (an EGR sensor) that controls the recycling amount of the exhaust gas from an automobile, and more specifically, to a structure for mounting a diode built in the EGR sensor.

2. Description of the Related Art

In a conventional diode-attached EGR valve device, a diode is connected in parallel to an excitation coil for driving the EGR valve that controls a circulating path of an exhaust gas so that a parallel circuit is constituted in the valve device (for example, see Japanese Unexamined Patent Application Publication No. 7-301155).

Hereinafter, the structure of the conventional EGR valve device will be described with reference to the accompanying drawings. FIG. 4 is a cross-sectional view schematically illustrating the conventional EGR valve device. FIG. 5 is a circuit diagram of a linear solenoid of the conventional EGR valve device.

In FIG. 4, an electromotive EGR valve device 101 is mainly divided into three parts: an upper part is a position sensor 102, a middle part is a linear solenoid 103, and a lower part is a valve mechanism 104.

The linear solenoid 103 of the middle part is interposed between an upper stator 110 and a lower stator 111, and coils 112 are disposed in a ring shape. An armature 113 is fitted in an empty space between the inner circumferential walls of the stators 110 and 111 such that the armature 113 can be freely elevated and is elastically supported toward the upside by return springs 114. In addition, a shaft 116 is supported by a bearing 115 attached to the center of the lower stator 111 so as to slide upward or downward. The upper end of the shaft 116 is fixed to the center of the armature 113 so as to be elevated in a body.

A valve 118 is formed at the lower end of the lower half of the shaft 116 protruding to the valve mechanism 104. A part of the circulating path of the exhaust gas is formed in the valve base 120 of the valve mechanism 104. A valve sheet 122 is positioned in the middle of the circulating path 121 in the valve base 120, so that the valve 118 at the lower end of the shaft 116 can be attached to and detached from the valve sheet 122 so as to be freely opened and closed.

On the other hand, in the upper position sensor 102, a rod 130 that is supported so as to vertically rise and fall protrudes toward the center of the linear solenoid 103 such that the lower end of the rod 130 comes into contact with the armature 113. The upper end of the rod 130 serves as a brush holder 131 to support a brush 132 in a side direction in a protruding manner. In addition, the brush holder 131 is elastically supported downward by return springs 133. A lift amount-detecting portion 134 is provided at the portion in which the brush 132 is brought into sliding contact with, so that it is possible to detect the lift amount at the position in which the brush 132 is brought into sliding contact with.

In addition to the above-mentioned configuration, in the electromotive EGR valve device 101, a free wheeling diode 142 is interposed between lead wires 140 and 141 extending from both ends of the coil 112 of the linear solenoid 103, and the free wheeling diode 142 is built in the position sensor 102. As shown in FIG. 5, a cathode terminal of the free wheeling diode 142 is connected to the lead wire 140 on the signal input side of the solenoid, and an anode terminal thereof is connected to the lead wire 141 on the ground side of the solenoid.

As such, since a parallel circuit in which the diode 142 is connected in parallel to the excitation coil 112 is constituted, the diode 142 serves as a free wheeling diode when an excitation current is off. As a result, the current circulates through a closed circuit, and then the current can be uniformly maintained. Therefore, the electromotive EGR valve device 101 is not affected by a change of a circuit on the control side, such as an ECU, and thus a stable performance can be exhibited.

However, according to the above-mentioned conventional EGR sensor, when the diode 142 is mounted to the position sensor 102 in a reverse direction, an electrical failure occurs because the diode 142 has polarity. Therefore, a worker must mount the diode 142 to the position sensor 102 while recognizing the mounting direction of the diode 142 to the position sensor 102, which complicates work.

In addition, when an error in mounting is generated, an electrical failure occurs in a circuit, so that an unstable performance can be exhibited.

### SUMMARY OF THE INVENTION

Accordingly, the present invention is designed to solve the above-mentioned problems, and it is an object of the present invention to provide a structure for mounting an electronic component that is capable of preventing an electronic component having polarity, such as a diode, from being mounted in a reverse direction, of simplifying workability, and of preventing the generation of an electrical failure in a circuit.

As a first aspect of the present invention in order to solve the above-mentioned problems, the present invention provides a structure for mounting an electronic component comprising: an electronic component including an element portion having polarity and a pair of lead terminals linearly extending from both ends of the element portion; and a holding member including a pair of electrode portions which is electrically connected to connection portions of the pair of lead terminals, wherein the pair of lead terminals of the electronic component is formed to have different lengths, and an abutting portion for positioning the element portion of the electronic component is provided in the holing member, wherein the abutting portion is formed between the pair of electrode portions at a position leaning toward one of the electrode portions from their midpoint, wherein, when the electronic component is mounted in the holding member at a reverse position, the element portion abuts to the abutting portion, and then at least one of the connection portions of the lead terminals is detached from one of the pair of the electrode portions.

According to a second aspect of the present invention, the abutting portion comprises a pair of guide walls, and both ends of the element portion are guided by the pair of guide walls. In addition, the electronic component is arranged between the pair of electrode portions at a position leaning toward one of the electrode portions from their midpoint. Thus, when the element portion is inserted between the pair of guide walls at a normal position, the connection portions of the pair of lead terminals come into contact with the pair of electrode portions, and when the element portion is inserted between the pair of guide walls at a reverse position, a short lead terminal of the lead terminals does not come into contact with one of the electrode portions.

According to a third aspect of the present invention, the electronic component is positioned and held between the pair of guide walls in the holding member.

As described above, a structure for mounting an electronic component according to the present invention comprises: an electronic component including an element portion having polarity and a pair of lead terminals linearly extending from both ends of the element portion; and a holding member including a pair of electrode portions which is electrically connected to connection portions of the pair of lead terminals. The pair of lead terminals of the electronic component is formed to have different lengths, and an abutting portion for positioning the element portion of the electronic component is provided in the holing member. The abutting portion is formed between the pair of electrode portions at a position leaning toward one of the electrode portions from their midpoint. Thus, when the electronic component is mounted in the holding member at a reverse position, the element portion abuts to the abutting portion, and then at least one of the connection portions of the lead terminals is detached from one of the pair of the electrode portions. Accordingly, when the electronic component is mounted in a direction opposite to a normal direction, the element portion of the electronic component abuts to the abutting portion, and thus it is impossible to connect the lead terminals to the electrode portions. As a result, it is possible to prevent the generation of an error in mounting because the worker can easily recognize that the electronic component is mounted in a reverse direction.

In addition, the abutting portion comprises a pair of guide walls, and both ends of the element portion are guided by the pair of guide walls. Further, the electronic component is arranged between the pair of electrode portions at a position leaning toward one of the electrode portions from their midpoint. When the element portion is inserted between the pair of guide walls at a normal position, the connection portions of the pair of lead terminals come into contact with the pair of electrode portions. On the other hand, when the element portion is inserted between the pair of guide walls at a reverse position, a short lead terminal of the lead terminals does not come into contact with one of the electrode portions. As a result, when the element portion is inserted between the pair of guide walls at a normal position, it is possible to electrically connect the electrode portions to the lead terminals. On the other side, when the element portion is inserted between the pair of guide walls at a reverse position, it is impossible to electrically connect the electrode portions to the lead terminals. Thus, when the element portion is inserted between the pair of guide walls at a reverse position, it is possible to prevent the generation of an error in mounting because the worker can easily recognize that the element portion is mounted in a reverse direction.

Furthermore, since the electronic component is positioned and held between the pair of guide walls in the holding member, the electronic component can be surely positioned and mounted in the holding member.

### BRIEF DESCRIPTION OF THE DRAWINGS

FIG. 1 is a front view of an EGR sensor serving as a holding member of an electronic component of the present invention;

FIG. 2 is an explanatory view illustrating a state in which an electronic component is mounted to a holding member according to an embodiment of the present invention;

FIG. 3 is an explanatory view illustrating a state in which an electronic component is mounted to a holding member according to another embodiment of the present invention;

FIG. 4 is a schematic cross-sectional view of a conventional EGR valve device; and

FIG. 5 is a circuit diagram of a linear solenoid of the conventional EGR valve device.

### DESCRIPTION OF THE PREFERRED EMBODIMENTS

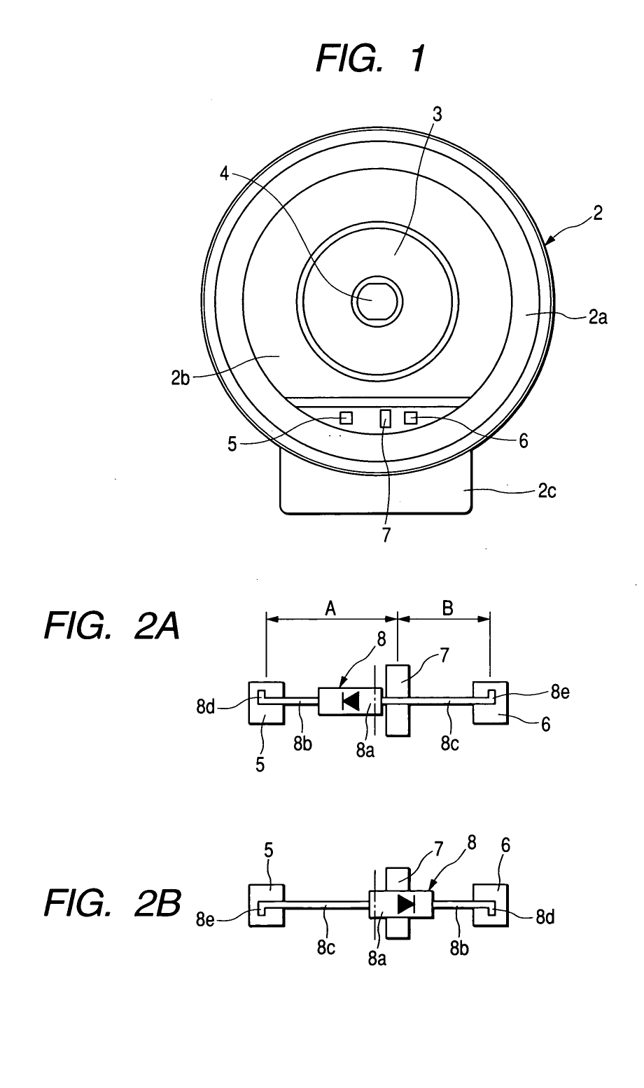

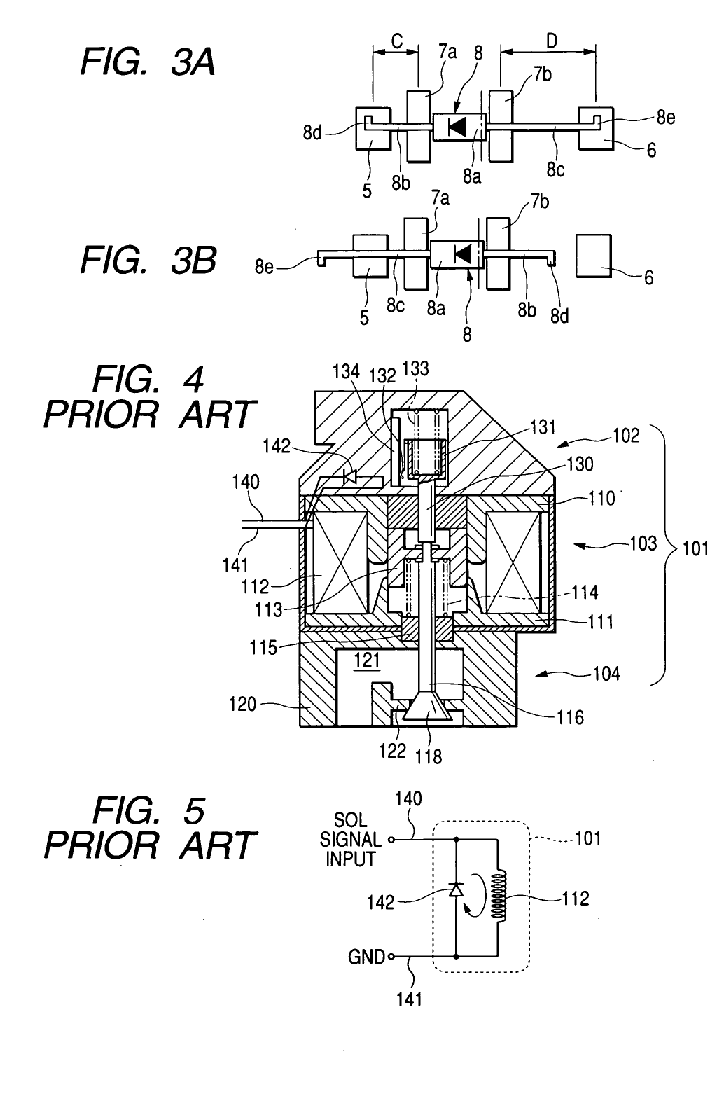

Hereinafter, a structure for mounting an electronic component according to the embodiments of the present invention will be described with reference to FIGS. 1 to 3. FIG. 1 is a front view of an EGR sensor, which is a holding member having the structure for mounting an electronic component of the present invention. FIG. 2 is a diagram illustrating a state in which an electronic component is mounted to a holding member according to an embodiment of the present invention; FIG. 2A is an explanatory view illustrating a state in which the electronic component is mounted to the holding member at a normal position; and FIG. 2B is an explanatory view illustrating a state in which the electronic component is mounted to the holding member at a reverse position. FIG. 3 is a diagram illustrating a state in which an electronic component is mounted to a holding member according to another embodiment of the present invention; FIG. 3A is an explanatory view illustrating a state in which the electronic component is mounted to the holding member at a normal position; and FIG. 3B is an explanatory view illustrating a state in which the electronic component is mounted to the holding member at a reverse position.

In FIG. 1, an EGR sensor 1 comprises a case 2 made of an insulating material, such as synthetic resin, a lid 3 that is made of an insulating material, such as synthetic resin, and covers a front surface of the case 2, and an operation shaft 4 inserted slidably in an axial direction with respect to an axis hole provided in the center of the lid 3.

The case 2 comprises a front wall 2a formed in a disc shape in plan view and provided along an outer circumference of the case 2, a concave groove portion 2b provided in an annular shape and having stepped portions formed in an inner circumference of the front wall 2a, a housing portion (not shown) provided at the center of the concave groove portion 2b such that one side is opened and the inside of the housing portion has a hollow shape, and a tubular portion 2c protruding downward from the outside of the housing portion.

In addition, although not shown, an insulating substrate in which a resistor is formed is attached to the housing portion. A movable member is mounted to the operation shaft 4 to move according to the movement of the operation shaft 4, and a slider member composed of a metal plate is mounted on the lower side of the movable member. In addition, the movable member to which the slider is mounted is attached to the case 2 to be slidable in the housing portion in a state in which the slider comes into contact with the resistor. Detecting means of a position sensor comprises a variable resistor composed of the resistor and the slider.

In addition, a connection clip connected to the resistor is drawn from the insulating substrate (not shown). The connection clip is electrically connected to one end of a pin terminal for an L-shaped connector buried in the case 2. In addition, the other end of the pin terminal protrudes toward an opening of the tubular portion 2c. The detecting signal from the sensor unit is output to an EGR valve device through the pin terminal.

Further, on the bottom surface side of the concave groove portion 2b of the case 2, a pair of electrode portions 5 and 6 composed of a conductive metal plate protrudes such that they are spaced apart from each other by a predetermined interval. In addition, a protrusion-shaped abutting portion 7 protruding from the bottom surface of the concave groove portion 2b is provided between the pair of electrode portions 5 and 6. Furthermore, the abutting portion 7 is formed between the pair of electrode portions 5 and 6 at a position leaning toward the electrode portion 6. In other words, a distance B from the electrode portion 6 on the right side to the abutting portion 7 is smaller than a distance A from the electrode portion 5 on the left side to the abutting portion 7. Further, the pair of electrode portions 5 and 6 is connected to the pin terminal (not shown) buried in the case 2, and the other end of the pin terminal protrudes toward an opening of the tubular portion 2c. The pair of electrode portions 5 and 6 is connected to signal input portions at both ends of a solenoid coil of the EGR valve device via the pin terminal.

FIG. 2 shows a state in which an electronic component, that is, a diode 8 is mounted to the case 2 of the EGR sensor 1, which is the holding member of the electronic component. In this case, the diode 8 comprises an element portion 8a into which a semiconductor element having polarity is inserted and a pair of lead terminals 8b and 8c extending from both ends of the element portion 8a. The lengths of the lead terminals 8b and 8c are different from each other, a first connection portion 8d is provided at a tip of the short lead terminal 8b, and a second connection portion 8e is provided at a tip of the long lead terminal 8c. In this case, the first connection portion 8d serves as a cathode terminal, and the second connection portion 8e serves as an anode terminal.

FIG. 2A illustrates a state in which the diode 8 is mounted at a normal position. In this case, the short lead terminal 8b is arranged on the left side, and the long lead terminal 8c is arranged on the right side. Since the element portion 8a does not abut to the abutting portion 7, the first connection portion 8d on the left side is electrically connected to the electrode portion 5, and the second connection portion 8e on the right side is electrically connected to the electrode portion 6. In this case, the diode 8 is normally mounted.

On the other hand, FIG. 2B illustrates a state in which the diode 8 is mounted at a reverse position. In this case, the short lead terminal 8b is arranged on the right side, and the long lead terminal 8c is arranged on the left side. Since the element portion 8a abuts to the abutting portion 7, the diode 8 comes off from the bottom surface, which is a mounting surface of the case 2. As a result, the first connection portion 8d or the second connection portion 8e is detached from the electrode portion 5 or 6, which makes it impossible to electrically connect each other. Accordingly, in this case, it is easy for the worker to recognize that the diode 8 is mounted in a reverse direction.

As such, the pair of lead terminals 8b and 8c of the diode 8 is formed to have different lengths, the abutting portion 7 for positioning the element portion 8a of the diode 8 is provided in the case 2, and the abutting portion 7 is formed between the pair of electrode portions 5 and 6 at a position leaning toward the electrode portion 6. When the diode 8 is mounted to the case 2 at a reverse position, the element portion 8a abuts to the abutting portion 7. As a result, at least one of the connection portions 8d and 8e of the lead terminals 8b and 8c is detached from one of the pair of the electrode portions 5 and 6. Accordingly, when the diode 8 is mounted in a direction opposite to a normal direction, the element portion 8a of the diode 8 abuts to the abutting portion 7, and thus it is impossible to connect the lead terminals 8b and 8c to the electrode portions 5 and 6. Thus, it is possible to prevent the generation of an error in mounting because the worker can easily recognize that the diode 8 is mounted in a reverse direction.

FIG. 3 illustrates the structure of the abutting portion 7 formed in the concave groove portion 2b of the case 2 according to another embodiment of the present invention. In this case, the abutting portion 7 comprises a pair of guide walls 7a and 7b opposite to each other. Both ends of the element portion 8a of the diode 8 are guided by the guide walls 7a and 7b, and the diode 8 is arranged between the pair of electrode portions 5 and 6 at a position leaning toward one of the electrode portions from their midpoint. In other words, a distance D from the guide wall 7b on the right side of the pair of guide walls to the electrode portion 6 is larger than a distance C from the guide wall 7a on the left side of the pair of guide walls to the electrode portion 5.

FIG. 3A illustrates a state in which the diode 8 is mounted at a normal position. In this case, the short lead terminal 8b is arranged on the left side, and the long lead terminal 8c is arranged on the right side. Both ends of the element portion 8a are guided by the pair of guide walls 7a and 7b in a state in which the element portion 8a is inserted therebetween. The first connection portion 8d on the left side is electrically connected to the electrode portion 5, and the second connection portion 8e on the right side is electrically connected to the electrode portion 6. In this case, the diode 8 is normally mounted.

On the other hand, FIG. 3B illustrates a state in which the diode 8 is mounted at a reverse position. In this case, the short lead terminal 8b is arranged on the right side, and the long lead terminal 8c is arranged on the left side. Both ends of the element portion 8a are guided by the pair of guide walls 7a and 7b in a state in which the element portion 8a is inserted therebetween. However, since the short lead terminal 8b is arranged on the right side, the length of the lead terminal 8b is smaller than the distance D from the guide wall 7b on the right side of the pair of guide walls to the electrode portion 6. As a result, the first connection portion 8d on the right side is detached from the electrode portion 6, and thus it is impossible to electrically connect to each other. Accordingly, in this case, the worker can easily recognize that the diode 8 is mounted in a reverse direction.

As such, when the element portion 8a is inserted between the pair of guide walls 7a and 7b at a normal position, the connection portions 8d and 8e of the pair of lead terminals 8b and 8c come into contact with the electrode portions 5 and 6. On the other hand, when the element portion 8a is inserted between the pair of guide walls 7a and 7b at a reverse position, the short lead terminal 8b of the lead terminals 8b and 8c does not come into contact with the electrode portion 6. Accordingly, when the element portion 8a is inserted between the pair of guide walls 7a and 7b at a normal position, the electrode portions 5 and 6 can be electrically connected to the lead terminals 8b and 8c. On the other hand, when the element portion 8a is inserted between the pair of guide walls 7a and 7b at a reverse position, the electrode portions 5 and 6 cannot be electrically connected to the lead terminals 8b and 8c. Therefore, it is possible to prevent the generation of an error in mounting because the worker can easily recognize that the element portion 8a is mounted in a reverse direction.

In addition, since the diode 8, which is an electronic component, is positioned and held between the pair of guide walls 7a and 7b in the concave groove portion 2b of the case 2, which is a holding member, it is possible to surely mount the diode 8 in the case 2.

The EGR sensor 1 having the above-mentioned configuration is assembled into the solenoid of the EGR valve device by a set maker. The solenoid comprises a hollow coil and a rod composed of an iron core that is provided at the center of the coil and is connected to the EGR valve. The rod is elasticity connected to the operation shaft 4 of the EGR sensor 1.

The operation of the EGR sensor 1 will now be described. When the operation shaft 4 is pressed by the rod of the solenoid for driving the EGR valve of an automobile, the movable member moves in an axial direction by the operation shaft 4. Then, the slider attached to the movable member moves onto the resistor of the insulating substrate. As a result, a resistance value of the variable resistor varies, and thus the movement amount of the operation shaft 4 can be detected.

In the EGR sensor 1 according to the present embodiment, the diode 8 is intervenient to signal input portions at both ends of the solenoid coil for driving the EGR valve. The first connection portion 8d (cathode terminal) of the diode 8 is connected to the signal input side (plus side) of the solenoid. The second connection portion 8e (anode terminal) the diode 8 is connected to the ground side (minus side) of the solenoid.

Since a duty signal for on/off switching is input to the coil of the solenoid, a normal current becomes unstable due to the inductance of the coil at the time when a current is decreased. However, since the diode 8 is intervenient to signal input portions at both ends of the solenoid coil for driving the EGR valve, the diode 8 is forward biased by the electromagnetic energy accumulated in the coil when an excitation current is off. As a result, the current circulates through a closed circuit composed of the coil and the diode 8, thereby maintaining the current uniformly. As such, since the uniform current is supplied to the coil, it is possible to achieve a stable performance.

1. A structure for mounting an electronic component, comprising:
an electronic component including an element portion having polarity and a pair of lead terminals linearly extending from both ends of the element portion; and
a holding member including a pair of electrode portions which is electrically connected to connection portions of the pair of lead terminals,
wherein the pair of lead terminals of the electronic component is formed to have different lengths, and an abutting portion for positioning the element portion of the electronic component is provided in the holing member,
wherein the abutting portion is formed between the pair of electrode portions at a position leaning toward one of the electrode portions from their midpoint, and
wherein, when the electronic component is mounted in the holding member at a reverse position, the element portion abuts to the abutting portion, and then at least one of the connection portions of the lead terminals is detached from the pair of the electrode portions.

2. The structure for mounting an electronic component according to claim 1,
wherein the abutting portion comprises a pair of guide walls,
wherein both ends of the element portion are guided by the pair of guide walls, and the electronic component is arranged between the pair of electrode portions at a position leaning toward one of the electrode portions from their midpoint, and
wherein, when the element portion is inserted between the pair of guide walls at a normal position, the connection portions of the pair of lead terminals come into contact with the pair of electrode portions, and when the element portion is inserted between the pair of guide walls at a reverse position, a short lead terminal of the lead terminals does not come into contact with one of the electrode portions.

3. The structure for mounting an electronic component according to claim 2,
wherein the electronic component is positioned and held between the pair of guide walls in the holding member.
